(19) United States
(12) Patent Application Publication
(10) Pub. No.: US 2002/0162407 A1
(43) Pub. Date: Nov. 7, 2002

(54) Oil drainage structure for a combustion engine crank case or the like, and method for oil drainage

(76) Inventors: Scott Nightlinger, Mount Prospect, IL (US); Agnieszka Nightlinger, Mount Prospect, IL (US); Piotr Loniewski, Warsaw (PL); Grzegorz Loniewski, Warsaw (PL)

Correspondence Address: Scott Nightlinger, 203 North Eastwood Avenue, Mount Prospect, IL, 60056-2416, US

(21) Appl. No.: 10/139,405

(22) Filed: May 6, 2002

(30) Foreign Application Priority Data
May 7, 2001 (PL) P347401

(51) Int. Cl. G04B 15/00

(52) U.S. Cl. 74/1.5

(57) ABSTRACT

Improved oil drainage structure and method of drainage for a combustion engine crank case oil pan or the like. This drainage structure provides safe operation along with simple and low cost manufacture and installation in both already existing and newly manufactured crank case oil pans. The improved drainage structure consists of an improved oil drain plug and holding means. The head of the oil drain plug possesses an additional recess designed to facilitate operational engagement with a correspondingly designed elongated holding means. The oil drain plug, elongated holding means, and associated method for unscrewing and removing the oil drain plug allow for the safer, simpler, and cleaner drainage of the used and hot oil.

### STATEMENT REGARDING FEDERALLY SPONSORED RESEARCH OR DEVELOPMENT

Not Applicable

### REFERENCE TO A MICROFICHE APPENDIX

Not Applicable

### BACKGROUND OF THE INVENTION

The present invention relates to an oil drainage assembly, more particularly towards a combustion engine crank case oil drainage structure, and method for oil drainage. The conventional oil drain plug is to be replaced with another having an improved structure whereby the drainage of used oil may be completed in a safer, simpler, and cleaner manner.

In the maintenance of various mechanical equipment such as automobiles, trucks, tractors, heavy earth movers, lawn mowers, military equipment or the like, even including certain stationary equipment, one of the most important schedules that must be observed is the regular changing of the engine oil. Internal combustion engines use motor oil to lubricate and cool their mechanical components. The task of changing this oil requires removal of the oil plug, drainage of the used and contaminated oil, and reinsertion of the oil plug prior to refilling with new and clean oil. On most equipment, the oil drain plug is located in the sidewall at the lowermost region of the oil collection pan so that gravity is utilized to completely empty the engine oil pan of the contaminated oil. The oil drains best when heated by normal engine operation and is therefore less viscous. Thus, it is common practice for the oil to be changed shortly after engine operation so that the oil is less viscous and drains more efficiently.

In prior art, a wrench has generally been required for the loosening and initial unscrewing of the drain plug from the oil pan, upon which an operator's hands would normally be used to complete the procedure. Using a wrench in this manner for changing oil is very simple, inexpensive, and is most often utilized because it does not require the use of complicated and expensive devices that can be difficult to implement. An oil drainage structure that requires a wrench for this technique is best shown in FIG. 1. This structure generally consists of an oil drain plug with a threaded stem 5 which, in use extends into the oil pan 20 through a threaded opening, and a head 10 which extends exteriorly of the oil pan and is shaped to facilitate the operational engagement of a wrench. The oil drain plug is usually then unscrewed and removed by hand to allow the engine oil to drain into an oil collection receptacle.

Changing the oil in vehicle engines is perhaps the most common task performed and most vehicle engines hold at least several liters of oil. The pressure on an oil drain plug can therefore be considerable. With this common technique, the heated engine oil usually begins to leak through the threads of the oil drain pan opening once the plug is loosened. When the plug is at last unscrewed and removed, the heated and contaminated oil usually gushes out of the oil drain pan, often spilling onto the operator's hands and clothing. This common technique is oftentimes clumsy at the critical point when the pressure of the oil is pushing on the plug and the operator is attempting to remove the oil drain plug in the cleanest manner possible, knowing that he may become unnecessarily messy and possibly even burned by the hot and contaminated oil.

This knowledge often encourages the operator to hurry in completing the task of unscrewing and removing the oil drain plug from the oil pan due to the oil leakage and spray inherent in this oil drainage structure and method. This haste often results in dropping the oil drain plug, requiring a messy search for the oil drain plug in the oil collection receptacle.

Contact between the operator's skin and the heated and contaminated oil has detrimental effects to the operator's health. This repeated and prolonged contact with contaminated engine oil has been shown to cause skin cancer and is warned against by oil manufacturers. Furthermore, this procedure is not only messy, but it is also immediately unsafe for the operator because the heated and contaminated oil may be hot enough to cause serious burns. Thus, this situation is of particular importance to professional operators who have continuous contact with this heated and contaminated oil due to their profession. Non-professional operators are likewise concerned about the detrimental effects associated with this commonly used procedure due to their inexperience and lack of sufficient equipment normal to a professional environment. This concern shown by operators is valid and has been recognized by both the Environmental Protection Agency (EPA) and the Occupational and Safety Health Association (OSHA) through their respective safety regulations concerning this issue.

During the search conducted in this art, the following patents have been uncovered U.S. Pat. Nos. 3,727,638, 4,205,758, 4,485,853, 5,547,042, and 5,628,601.

Prior art has recognized the problem of leakage during drainage of oil from the oil pan, and some have provided structures, which attempt to prevent messy leakage around a drain plug. However, such prior art structures and methods are complicated, time consuming, and expensive to produce and utilize. Further, some of the prior art structures extend below the oil pan by which they are carried. These structures are thus subject to damage or require original equipment installation with a specially designed crank case oil pan at the time of production and are therefore not suitable for aftermarket sales in existing vehicles. Other structures extend into the crank case oil pan resulting in incomplete drainage.

It is therefore an object of the invention to provide an improved oil drainage structure and method of drainage for a combustion engine crank case oil pan or the like. This drainage structure provides a simple construction, economical manufacture, safety in use, and a low cost and uncomplicated installation in both already existing and newly manufactured crank case oil pans. The improved drainage structure consists of an improved oil drain plug and holding means that allows the safe, clean, and efficient removal of the drain plug when draining the oil from a combustion engine crank case oil pan.

### BRIEF SUMMARY OF THE INVENTION

The present invention comprises an oil drainage structure and method of removing an oil drain plug and draining the used and hot oil from the crank case oil pan of a combustion engine or the like.

In accordance with the invention, an oil drainage structure for a combustion engine crank case oil pan or the like, having an oil drain opening therethrough in a lower portion thereof having internal threads therein and an oil drain plug including a stem portion having external threads thereon and a head on one end of the stem portion adapted to facilitate screwing of the oil drain plug into and out of the oil drain opening, characterized in that the oil drain plug's head additionally includes at least one internal recess of predetermined shape for placing an elongated holding means during an oil exchange process. The elongated holding means has at least one end adapted to facilitate the operational engagement with the internal recess in the oil plug's head to unscrew and remove the oil drain plug from the oil drain threaded opening.

In accordance with the invention, as shown in FIG. 2, the internal recess in the externally shaped head of the oil drain plug constitutes an opening with left-handed thread therein.

In accordance with the modification of the invention, as shown in FIG. 3, the internal recess in the externally shaped head of the oil drain plug constitutes a recess for a bit socket.

In another modification of the invention, as shown in FIG. 3A, the internal recess for a bit socket in the externally shaped head of the oil drain plug includes at least one annular V-groove on the recess' walls.

In a further modification of the invention, as shown in FIG. 3B, the internal recess for a bit socket in the externally shaped head of the oil drain plug includes at least one annular channel on the recess' walls with a C-shaped spring therein.

In a still further modification of the invention, as shown in FIG. 4, the internal recess in the internally shaped head of the oil drain plug constitutes an opening with left-handed thread therein.

In a still further modification of the invention, as shown in FIG. 5, the internal recess in the internally shaped head of the oil drain plug constitutes at least one annular V-groove on the internal walls of the internally shaped head.

In a still further modification of the invention, as shown in FIG. 6, the internal recess in the internally shaped head of the oil drain plug constitutes at least one annular channel which includes a C-shaped spring installed therein.

In accordance with the invention, the elongated holding means, as shown in FIG. 3E, possesses an end driving portion substantially constituting a bit socket which comprises at least one annular V-groove.

In accordance with the modification of the invention, the elongated holding means, as shown in FIG. 3D, possesses an end driving portion substantially constituting a bit socket which comprises at least one annular channel with a C-shaped spring installed in the annular channel.

In accordance with another modification of the invention, the elongated holding means, as shown in FIG. 3C, possesses an end driving portion substantially constituting a bit socket which comprises a magnetic head secured at the end of the driving portion.

In a further modification of the invention, the elongated holding means, as shown in FIGS. 2B, 2C and 4B, possesses an end driving portion substantially constituting an arbor with left-handed threads thereon.

In accordance with the invention, the method of removing oil from a combustion engine crankcase oil pan or the like, having a threaded oil drain opening sealed by a threaded oil drain plug comprising an internal recess for placing an elongated holding means during an oil exchange process, comprises the steps of initially loosening the threaded oil drain plug with a tool, placing the elongated holding means in the internal recess of the oil drain plug's head, unscrewing and removing the loosened oil drain plug from the threaded oil drain opening with the elongated holding means placed in the internal recess of the oil drain plug's head, allowing the oil to flow out by gravity into a collection container, and reattaching said threaded oil drain plug with a sealing washer to said threaded oil drain opening and screwing with predetermined torque.

In accordance with the invention, the modification of the method of removing oil from a combustion engine crankcase oil pan or the like, having a threaded oil drain opening sealed by a threaded oil drain plug comprising an internal recess for placing an elongated holding means during an oil exchange process, comprises the steps of placing the elongated holding means in the internal recess of the oil drain plug's head, loosening the threaded oil drain plug in the threaded oil drain opening, unscrewing and removing the loosened oil drain plug from the threaded oil drain opening with the elongated holding means placed in the internal recess of the oil drain plug's head, allowing the oil to flow out by gravity into a collection receptacle, and reattaching said threaded oil drain plug with a sealing washer to said threaded oil drain opening and screwing with predetermined torque.

### BRIEF DESCRIPTION OF THE SEVERAL VIEWS OF THE DRAWING

FIG. 1 is a sectional view of an oil drainage structure in the lowermost region of an oil pan in a combustion engine; with a side view of a typical prior art oil drain plug.

FIG. 1A is an axial-end view of the head of a typical prior art oil drain plug as shown in FIG. 1.

FIG. 2 is a side view of an improved oil drain plug with a standard hex head and sealing flange, with a partially broken away section showing an additional recess constituting an axial opening with left-handed thread therein, in accordance with the structure and method of the invention.

FIG. 2A is an axial-end view of the head of the oil drain plug shown in FIG. 2.

FIG. 2B is a plain view of a holding means used to unscrew and remove the oil drain plug shown in FIG. 2 and FIG. 4, in accordance with the invention.

FIG. 2C is a plain view of an alternative holding means for unscrewing and removing the oil drain plug shown in FIG. 2, in accordance with the invention.

FIG. 3 is an axial-end view of the improved standard hex head of the oil drain plug having an axial recess for a bit socket, in accordance with the invention.

FIG. 3A is a side view of an alternative embodiment for an improved oil drain plug with a partially broken away section showing a recess for a bit socket, in a standard hex head, where the recess includes one annular V-groove, in accordance with the structure and method of the invention.

FIG. 3B is a side view of a second alternative embodiment for an improved oil drain plug with a partially broken away section showing a recess for a bit socket, in a standard hex head, where the recess includes one annular channel with a C-shaped spring installed in the channel, in accordance with the invention.

FIG. 3C is a side view of an alternative holding means for unscrewing and removing the oil drain plug shown in FIG. 3, FIG. 3A and FIG. 5 with a cross-sectional view of the end portion of a hex L-key, where the end portion possesses a secured annular magnetic head, in accordance with the invention.

FIG. 3D is a side view of an alternative holding means for unscrewing and removing the oil drain plug shown in FIG. 3A and FIG. 5 with a partially broken away section showing the end portion of a hex L-key, where the end portion possesses an annular channel with a C-shaped spring installed in the channel, in accordance with the invention.

FIG. 3E is a plain side view of an alternative holding means for unscrewing and removing the oil drain plug shown in FIG. 3B and FIG. 6, in which the end portion of a standard hex L-key possesses an annular V-groove at the tip of the end portion, in accordance with the invention.

FIG. 4 is a side view of a third alternative embodiment for an improved oil drain plug with a partially broken away section showing an additional recess in a standard socket head, for a standard hex key, constituting an axial opening with left-handed thread therein, in accordance with the invention.

FIG. 4A is an axial-end view of the head of the oil drain plug shown in FIG. 4, in accordance with the invention.

FIG. 4B is a plain side view of an alternative holding means for unscrewing and removing the oil drain plug shown in FIG. 4 and FIG. 2, where the end portion of a standard hex key possesses a machined end portion with left-handed thread thereon, in accordance with the invention.

FIG. 5 is a side view of a fourth alternative embodiment for an improved oil drain plug with a partially broken away section showing one annular V-groove in a standard socket head recess, in accordance with the invention.

FIG. 5A is an axial-end view of the head of the oil drain plug shown in FIG. 5.

FIG. 6 is a side view of a fifth alternative embodiment for an improved oil drain plug with a partially broken away section showing one annular channel in a standard socket head recess with a C-shaped spring installed in the channel, in accordance with the invention.

### DETAILED DESCRIPTION OF THE INVENTION

The detailed description is presented to illustrate the present invention but is not intended to limit it.

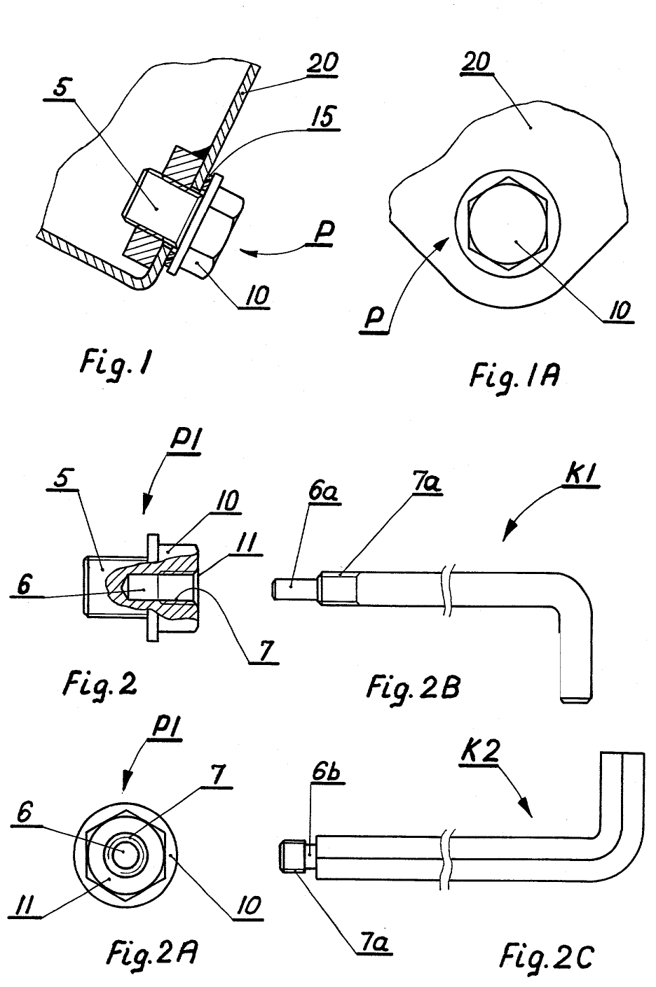

In more detail, a typical combustion engine oil drainage structure is shown best in FIG. 1 and FIG. 1A, of the drawings, located in the lowermost region of a crank case oil pan 20 of an internal combustion engine (not shown in further detail). The lowermost portion of the oil pan 20 includes a nut welded thereto (not indicated), has a threaded opening extending therethrough in which the drain plug P is installed. The typical drain plug P includes a threaded stem portion 5 and head portion 10. Usually the head portion 10 is provided with a hexagonal peripheral configuration, shown best in FIG. 1A, to permit engagement of the head portion 10 by a wrench or the like, for initial loosening of the drain plug from the oil pan 20. In assembly, a sealing washer 15 is placed between the head 10 of the drain plug P and the wall of the oil pan 20.

In order to prevent the undesired direct exposure of service technicians to dirty and hot oil during the process of draining the used oil, a preferred embodiment of an oil drain plug structure is shown best in FIG. 2 and FIG. 2A.

The improved oil drain plug P1 has a stem portion 5 and a head portion 10, preferably with a hexagonal peripheral configuration, to permit engagement of the head portion 10 by a wrench for initial loosening of the drain plug P1 from the oil pan when it is desired to drain oil from an oil pan and then screw the drain plug P1 back into the oil pan opening after draining. The hex flange head 10 from a face side 11 additionally comprises an axially-extended opening 6 constituting a round hole with left-handed thread 7 in which is placed a holding means K1 shown in FIG. 2B or K2 shown FIG. 2C to unscrew and remove the oil drain plug P1 from an oil drain opening without direct contact of hot used oil with the user's hand. The oil drain plug holding means K1 shown in FIG. 2B is made out of a round steel rod and shaped like an L-key. The longer arm possesses a machined end portion 6a with a circular cross-section and left-handed thread 7a thereon.

An alternative oil drain plug holding means K2 shown in FIG. 2C for unscrewing and removing the oil drain plug shown in FIG. 2 and FIG. 2A constitutes a typical Allen hex key with machined end portion 6b with left-handed thread 7a thereon.

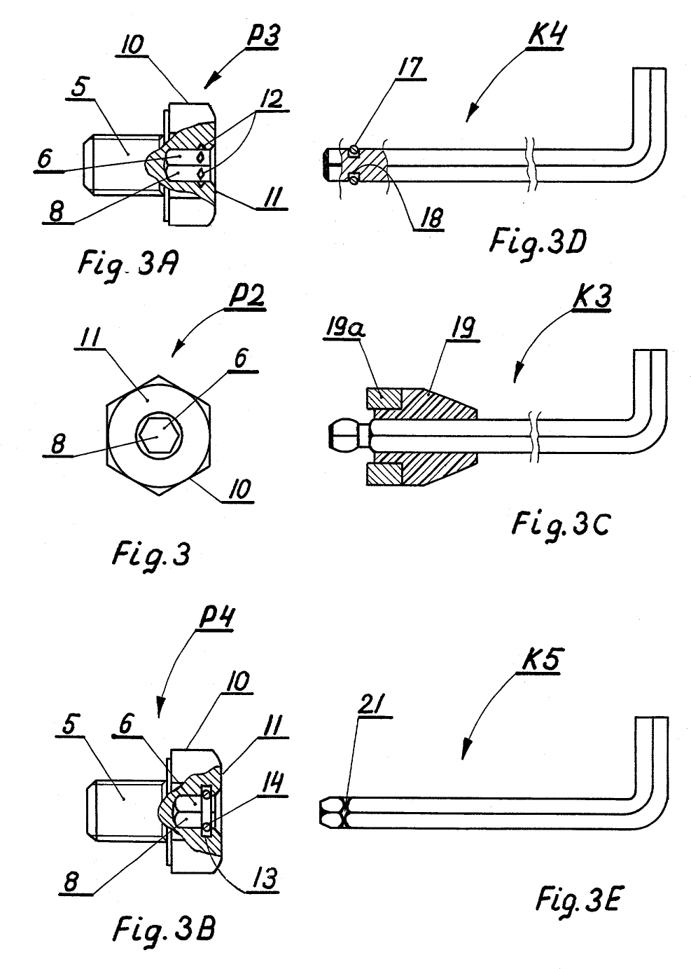

A first alternative oil drain plug structure is shown in FIG. 3. The oil drain plug P2 with a typical hex head 10 from a face side 11 additionally comprises an axially extending opening 6 constituting a typical recess 8 for a hex socket bit.

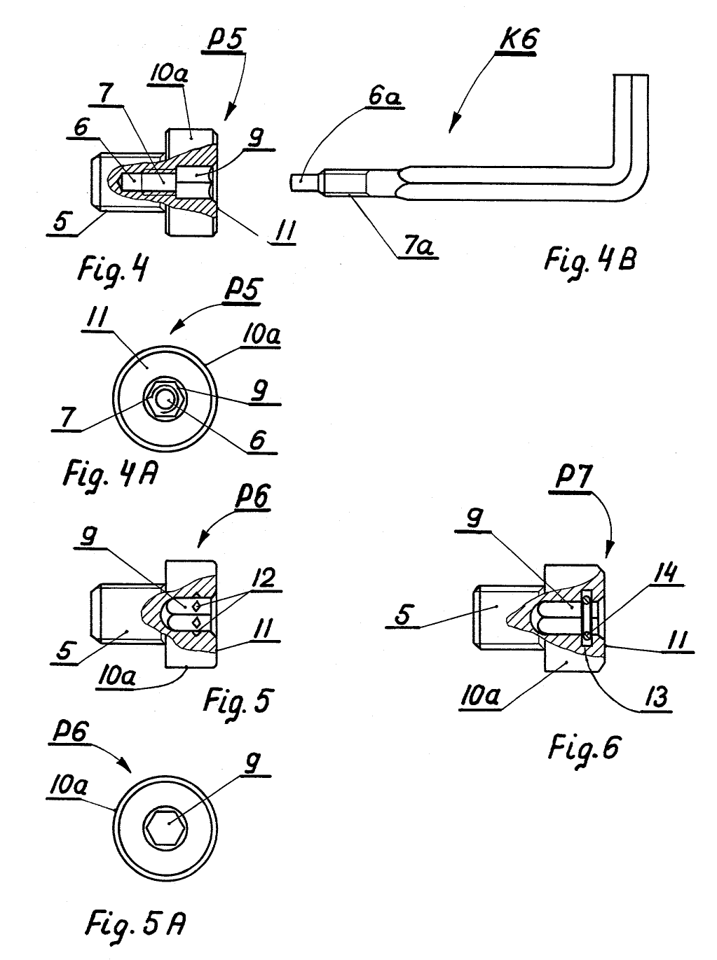

A second alternative embodiment of the oil drain plug structure is shown in FIG. 3A. The oil drain plug P3 has a typical hex head and comprises a hexagonal axial recess 8 in face 11. The hex head 10 further comprises one annular machined V-groove 12 on the side walls of the recess 8. The oil drain plug P3 is unscrewed and removed from an oil drain opening with an oil plug holding means K4, shown in FIG. 3D. The holding means K4 constitutes a typical Allen hex L-key with one machined annular channel 18 at the end of the longer arm. The channel 18 comprises a C-shaped spring 17 installed therein. The C-shaped spring 17, has a relaxed external diameter substantially greater than the internal diameter of the recess 8 in FIG. 3A into which it is to be placed, whereby the C-shaped spring 17 tends to compress and grip the walls of the V-groove 12 in the recess 8 of the oil drain plug P3. The holding means K4 can also be utilized for loosening, unscrewing, and removing the oil drain plug shown in FIG. 3, FIG. 4, and FIG. 5.

The oil drain plugs shown in FIG. 3, FIG. 3A, FIG. 4, FIG. 5, and FIG. 6 can be loosened, unscrewed, and removed with the alternate holding means K3, shown in FIG. 3C. The holding means K3 constitutes a typical Allen hex L-key with an annular magnetic head 19. The head 19 comprises an annular magnetic insert 19A. The magnetic head 19 is permanently secured at the end of the elongated arm of the hex L-key. The end of the hex L-key extends beyond the magnetic head by a length less than the depth of the recess 8 in the head 10 of the drain plug shown in FIG. 3A, FIG. 5, or FIG. 6. The magnet ring 19a tends to hold the oil drain plug on face 11.

A third alternative embodiment of the oil drain plug structure is shown in FIG. 3B. The oil drain plug P4 has a typical hex head 10 and comprises a hexagonal axial recess 8 in face 11. The hex head 10 further comprises one annular internal channel 13 on the recess walls with a C-shaped steel spring 14 installed therein. The C-shaped steel spring 14 has a relaxed internal diameter substantially smaller than the internal diameter between the opposite walls of the recess 8, whereby the C-shaped spring 14 tends to extend and grip the V-groove 21 of the oil drain plug holding means KS shown in FIG. 3E. The oil drain plug holding means K5 may constitute a typical Allen hex L-key with one machined annular external V-groove 21 at the end of the larger arm.

A fourth alternative embodiment of the oil drain plug structure is shown in FIG. 4 and FIG. 4A. The oil drain plug P5 comprises a typical socket head 10a with a recess 9 for a typical hex socket bit or Allen hex L-key. The oil drain plug P5 further comprises an axially-extended opening 6 constituting a hole with left-handed thread 7 therein. The oil drain plug P5 can be loosened, unscrewed, and removed from an oil drain opening by utilizing a holding means K6 shown in FIG. 4B, where a typical Allen hex L-key possesses a machined end portion 6a with a circular cross-section and left-handed thread 7a thereon.

A fifth alternative embodiment of the oil drain plug structure is shown in FIG. 5 and FIG. 5A. The oil drain plug P6 comprises a typical socket head 10a with a recess 9 for a typical hex socket bit or Allen hex L-key. The oil drain plug P6 further comprises one annular V-groove 12 on the side walls of the recess 9. The oil drain plug P6 can be loosened, unscrewed, and removed from an oil drain opening utilizing an oil drain plug holding means K4 shown in FIG. 3D and also holding means K3 shown in FIG. 3C.

A sixth alternative embodiment of the oil drain plug structure is shown in FIG. 6. The oil drain plug P7 comprises a typical socket head 10a with a recess 9 for a typical hex socket bit or Allen hex L-key. The oil drain plug P7 further comprises one annular channel 13 on the side walls of the recess 9, which includes a C-shaped spring 14 installed therein. The oil drain plug P7 can be loosened, unscrewed, and removed from an oil drain opening with the oil drain plug holding means K5 shown in FIG. 3E and also holding means K3 shown in FIG. 3C.

While the embodiment of the invention has been described in detail and modifications thereof suggested; it is understood that the above disclosures are not intended to be limiting. It is obvious that those skilled in the art may make various modifications and changes of the oil drainage structure and method retaining the teachings of the invention without departing from the scope and spirit of the present invention. It is to be expressly understood that the current invention is limited only by the appended claims.

What is claimed is:

1. An oil drainage structure for a combustion engine crank case or the like, having an oil drain opening therethrough in a lower portion thereof having internal threads therein and an oil drain plug including a stem portion having external threads thereon and a head on one end of the stem portion adapted to facilitate screwing of the oil drain plug into and out of the oil drain opening,
characterized in that said head additionally includes at least one internal recess having a predetermined shape for the placement of an elongated holding means having at least one end adapted to facilitate operational engagement with said internal recess in said head to unscrew and remove said oil drain plug from said oil drain threaded opening during an oil exchange process,
whereby the drainage of used and hot oil may be completed in a safer, simpler and cleaner manner.

2. Structure as set forth in claim 1, wherein said internal recess in an externally shaped head of said oil drain plug is substantially an axially-extended opening with left-handed thread therein.

3. Structure as set forth in claim 1, wherein said internal recess in an externally shaped head of said oil drain plug is substantially a recess for a bit socket.

4. Structure as set forth in claim 3, further including at least one annular V-groove on the recess' walls.

5. Structure as set forth in claim 3, further including at least one annular channel on the recess' walls, which includes a C-shaped spring installed therein.

6. Structure as set forth in claim 1, wherein said internal recess in an internally shaped head of said oil drain plug is substantially an axially-extended opening with left-handed thread therein.

7. Structure as set forth in claim 1, wherein said internal recess constitutes at least one annular V-groove on the internal walls of an internally shaped head.

8. Structure as set forth in claim 1, wherein said internal recess constitutes at least one annular channel on the internal walls of an internally shaped head, which further includes a C-shaped spring installed therein.

9. Structure as set forth in claim 1, wherein said elongated holding means possesses an end driving portion substantially constituting a bit socket which comprises at least one annular V-groove.

10. Structure as set forth in claim 1, wherein said elongated holding means possesses an end driving portion substantially constituting a bit socket which comprises at least one annular channel with a C-shaped spring installed in said annular channel.

11. Structure as set forth in claim 1, wherein said elongated holding means possesses an end driving portion substantially constituting a bit socket which comprises a magnetic head secured at the end of said end driving portion.

12. Structure as set forth in claim 1, wherein said elongated holding means possesses an end driving portion substantially constituting an arbor with left-handed threads thereon.

13. A method of removing oil from a combustion engine crankcase or the like, having a threaded oil drain opening sealed by a threaded oil drain plug comprising an internal recess for placement of an elongated holding means during an oil exchange process, comprising the steps of:
(a) initially loosening said threaded oil drain plug with a tool
(b) placing said elongated holding means in said internal recess of said threaded oil drain plug's head
(c) unscrewing and removing loosened oil drain plug from the threaded oil drain opening with said elongated holding means placed in said internal recess of said threaded oil drain plug
(d) allowing the oil to flow out by gravity into a collection receptacle
(e) reattaching said threaded oil drain plug to said threaded oil drain opening.

14. A method of removing oil from a combustion engine crankcase or the like, having a threaded oil drain opening sealed by a threaded oil drain plug comprising an internal recess for placement of an elongated holding means during an oil exchange process, comprising the steps of:
(a) placing in said internal recess of said threaded oil drain plug said elongated holding means
(b) loosening said threaded oil drain plug in said threaded oil drain opening
(c) unscrewing loosened oil drain plug with said elongated holding means placed in said internal recess of said threaded oil drain plug and removing said threaded oil drain plug from said threaded oil drain opening
(d) allowing the oil to flow out by gravity into a collection receptacle
(e) reattaching said threaded oil drain plug to said threaded oil drain opening.
